(19) United States
(12) Patent Application Publication
(10) Pub. No.: US 2022/0131394 A1
(43) Pub. Date: Apr. 28, 2022

(54) PORTABLE CHARGING SYSTEM WITH NETWORK CAPABILITIES

(71) Applicant: Hubbell Incorporated, Shelton, CT (US)

(72) Inventors: Shadi Alex AbuGhazaleh, Shelton, CT (US); Ryan David Bares, Torrington, CT (US); Christopher Lane Bailey, Greenville, SC (US)

(21) Appl. No.: 17/508,597

(22) Filed: Oct. 22, 2021

Related U.S. Application Data
(60) Provisional application No. 63/104,767, filed on Oct. 23, 2020.

(51) Int. Cl. H02J 7/00; H02J 13/00

(52) U.S. Cl. CPC H02J 7/0042; H02J 13/00026

(57) ABSTRACT

A portable charging system with network capabilities. The system includes a portable device including a rechargeable battery configured to supply a type of power to at least one external load device, and a portable device transceiver configured to provide communication to an external device.

### RELATED APPLICATION

This application claims priority to U.S. Provisional Patent Application No. 63/104,767, filed on Oct. 23, 2020, the entire contents of which are incorporated herein by reference.

### FIELD

Embodiments relate to portable power supplies, and more specifically, portable power supplies having networking capabilities.

### SUMMARY

There are a number of open or extended areas, such as fields, park, and/or other indoor/outdoor spaces where a permanent network infrastructure is not always needed, desired, and/or practical to deploy. Additionally, during certain events, such as fails, concerts, and/or other large gatherings, it may be necessary to provide additional network coverage.

Thus, one embodiment provides a portable charging system with network capabilities. The system includes a portable device including a rechargeable battery configured to supply a type of power to at least one external load device, and a portable device transceiver configured to provide communication to an external device.

Another embodiment provides a method of operating a portable device. The method including supplying a type of power, via a rechargeable battery, to at least one external load device. The method further providing communication, via a portable device transceiver, to an external device.

Such embodiments may provide network capabilities in areas that network coverage does not exist. Additionally, such an embodiment may serve as a flexible temporary infrastructure. Furthermore, such an embodiment may be used by “temporary” users/occupants of a space, such that guests may use embodiments disclosed herein for accessing a network from the user's/guest's personal device(s).

Other aspects of the application will become apparent by consideration of the detailed description and accompanying drawings.

### BRIEF DESCRIPTION OF THE DRAWINGS

FIG. 1 illustrates a portable device with network capabilities according to some embodiments.

FIG. 2 illustrates a diagram of the portable device of FIG. 1 according to some embodiments.

FIGS. 3A-3D illustrate diagrams of a portable device of FIG. 1 providing power and/or network communication to one or more external devices according to some embodiments.

FIG. 4 illustrates a network provided by one or more portable devices of FIG. 1 according to some embodiments.

FIG. 5 illustrates a charging system of one or more portable devices of FIG. 1 according to some embodiments.

FIG. 6 illustrates a diagram of the charging system of FIG. 5 according to some embodiments.

FIGS. 7A and 7B illustrate an example virtual boundary of the portable device(s) of FIG. 1 according to some embodiments.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

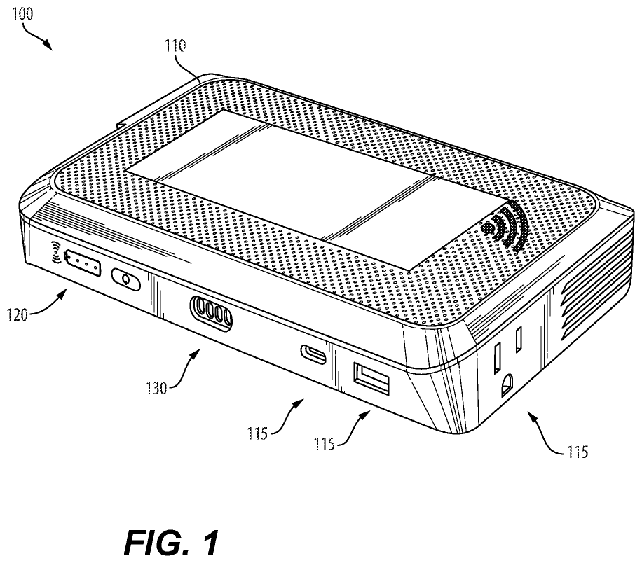

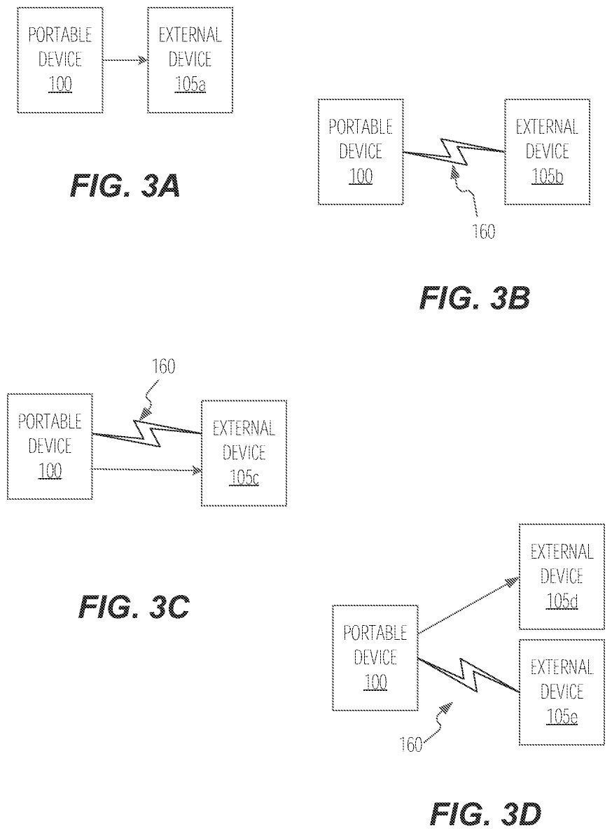

FIG. 1 illustrates a portable charging system with network capabilities (e.g., a portable device) 100 according to some embodiments. The portable device 100 may be configured to provide power and/or network capabilities to one or more external devices 105 (FIGS. 3A-3D).

In the illustrated embodiment, the portable device 100 includes a portable device housing 110. The portable device housing 110 is configured to encase the components of the portable device 100.

As illustrated, the portable device housing 110 may include one or more power outputs 115. The one or more power outputs 115 may be configured to connect/couple one or more external devices 105 to the portable device 100 to supply power and/or communication between the external device 105 and the portable device 100. In some embodiments, the power outputs 115 are configured to receive a power plug. As illustrated, the one or more power outputs 115 may be different power receptacles configured to output power of different types or having different characteristics (for example, different voltage amplitudes and/or magnitudes, different voltage frequencies, alternating current, or direct current). For example, a first power output 115 may be a direct current power receptacle configured to output power having approximately 12 VDC, a second power output 115 may be a North American power receptacle configured to output power having approximately 120 VAC, and a third power output 115 may be a Universal Serial Bus (USB) power output configured to output approximately 5 VDC. However, in other embodiments, the power outputs may be different. In other embodiments, the portable device 100 may be configured to wirelessly charge one or more of the portable devices 100, for example via inductive charging. In such embodiments, the wireless charging components may be contained within the housing 110 and located such that one or more external devices 105 may be placed upon the portable device 100 and charged wirelessly.

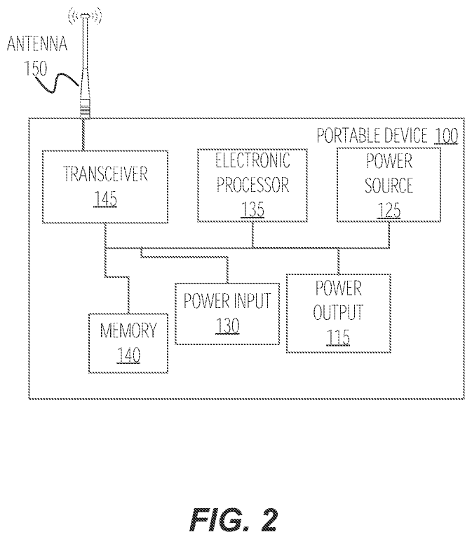

The portable device housing 110 may also include a user-interface 120 (including for example, one or more push buttons and one or more indicators). The user-interface 120 may be configured to receive input from a user (for example, via a push button) and/or indicate to the user an operational status of the portable device 100. The operational status could be, for example but not limited to, a voltage level of the power source 125 (FIG. 2) of the portable device 100, presence of an error condition, and a network connection status.

The portable device housing 110 may also include a power input 130. The power input 130 may be configured to receive power. Although illustrated as being a physical connection (for example, a USB port), in some embodiments, the power input may be an inductive charging device.

FIG. 2 illustrates a block diagram of the portable device 100 according to some embodiments. The portable device 100 may include an electronic processor 135, a memory 140, a transceiver 145, an antenna 150, the one or more power outputs 115, the power source 125, and the power input 130.

The electronic processor 135 obtains and provides information (for example, from the memory 140), and processes the information by executing one or more software instructions or modules, capable of being stored, for example, in a random access memory (“RAM”) area of the memory 140 or a read only memory (“ROM”) of the memory 140 or another non-transitory computer readable medium (not shown). The software can include firmware, one or more applications, program data, filters, rules, one or more program modules, and other executable instructions.

The memory 140 can include one or more non-transitory computer-readable media, and includes a program storage area and a data storage area. The program storage area and the data storage area can include combinations of different types of memory, as described herein. The electronic processor 135 is configured to retrieve from the memory 140 and execute, among other things, software related to the control processes and methods described herein.

The portable device 100 may be configured to communicate via the transceiver 145 and antenna 150. For example, the portable device 100 may communicate with one or more external devices 105 and/or various other apparatus/systems external to the portable device 100. The communication may be, for example, a wide area network (WAN), a transport control protocol/internet protocol (TCP/IP) based network, a cellular network, such as, for example, a Global System for Mobile Communications (or Groupe Special Mobile (GSM)) network, a General Packet Radio Service (GPRS) network, a Code Division Multiple Access (CDMA) network, an Evolution-Data Optimized (EV-DO) network, an Enhanced Data Rates for GSM Evolution (EDGE) network, a 1G network, a 3GSM network, a 4GSM network, a Digital Enhanced Cordless Telecommunications (DECT) network , a Digital advanced mobile phone system (AMPS) (IS-136/time division multiple access (TDMA)) network, or an Integrated Digital Enhanced Network (iDEN) network, etc.). In other embodiments, the communication links are, for example, a local area network (LAN), a neighborhood area network (NAN), a home area network (HAN), or personal area network (PAN) employing any of a variety of communications protocols, such as Wi-Fi, Bluetooth, ZigBee, etc. In some embodiments, in addition to or in lieu of the transceiver 145 and antenna 150, the portable device 100 may include in a I/O port for wired connections with the one or more external devices 105 and/or various other apparatus/systems external to the portable device 100.

The power source 125 may be a rechargeable battery. In some embodiments, the power source 125 is a lithium-ion battery. In other constructions, the power source 125 has a different chemistry, for example, but not limited to, a nickel-cadmium (NiCd) chemistry, a nickel-metal hydride (NiMH) chemistry, and a lithium-ion polymer (LiPo) chemistry. In some embodiments the portable device 100 further includes one or more of a rectifier, alternator, or other converter. The rectifier and/or alternator are configured to convert the power from the power source 125 to an appropriate output power to be output to the one or more external device 105. In other embodiments, the power source 125 may be, may include, or may be charged by, a solar array and/or a generator. For example, the generator may be a hand-crank generator, a windmill, and/or other form of generator.

In some embodiments, the portable device 100 is configured to charge the power source 125 by receiving power externally via power input 130. In such an embodiment, the portable device 100 may include charging circuitry to receive the power and charge the power source 125. In some embodiments, the power input 130 may be a wireless charging coil configured to wirelessly receive power. As mentioned above, in further embodiments, one or more of the at least one power output port(s) 115 may be a wireless charging coil configured to wirelessly transmit power to the external device(s) 105. In some embodiments, the power output 115 and power input 130 may be integrated into a single bi-directional port (or coil) configured to both transmit and receive power and output power to the external device(s) 105.

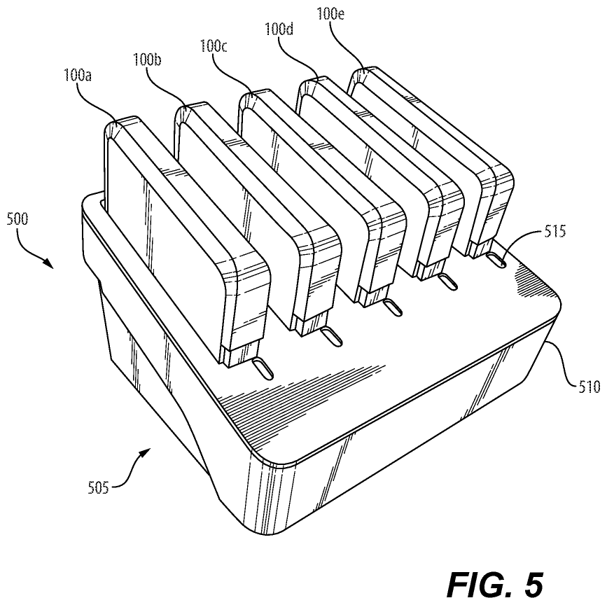

The portable device 100 may include one or more input/output components (for example, user-interface 120). In some embodiments, the portable device 100 is configured to generate a visual and/or audible alert to indicate a particular operational status. Such operational statuses may include a detected fault within the portable device 100, the power source 125 is low on charge, or the portable device 100 is outside the virtual boundary and has stopped supplying power to the external device 105. A visual indication may be provided via one or more light-emitting diodes (LEDs), a display, or an alarm. In some embodiments, the portable device 100 may be configured to forward information regarding the particular condition to one or more external devices, for example the external device 105, the charging station 505 (FIG. 5), or a remote server.

In some embodiments, the transceiver 145 and/or the antenna 150 is securely separated (or isolated) from the power output(s) 115 (for example, a USB power output) and/or the power input 130. This may be performed via physical and/or software-based separation. Such an embodiment may prevent unapproved/improper access to the network, while providing output power.

FIGS. 3A-3D illustrate various operations of the portable device 100 in conjunction with external device(s) 105 (and/or load device(s)) according to some embodiments. External device 105 may be any variety of external devices configured to receive power and/or communicate via network connectivity. For example, external device(s) 105 may be a laptop, a tablet, and/or a smart phone.

FIG. 3A illustrates portable device 100 providing power to external device 105a (e.g., a load device configured to receive power from portable device 100). As detailed above, power may be provided via a power output 115 (including via a wired and/or wireless connection). FIG. 3B illustrates portable device 100 providing network connectivity to external device 105b. As illustrated, portable device 100 may provide network connectivity via wireless connection 160.

FIG. 3C illustrates the portable device 100 providing power and network connectivity to external device 105c (e.g., a load device). As illustrated, portable device 100 may provide network connectivity via wireless connection 160. FIG. 3D illustrates the portable device 100 providing power to external device 105d (e.g., load device) and network connectivity to external device 105e. As illustrated, portable device 100 may provide network connectivity via wireless connection 160. As discussed above, the wireless connection 160 may be, for example, a wide area network (WAN), a transport control protocol/internet protocol (TCP/IP) based network, a cellular network, such as, for example, a Global System for Mobile Communications (or Groupe Special Mobile (GSM)) network, a General Packet Radio Service (GPRS) network, a Code Division Multiple Access (CDMA) network, an Evolution-Data Optimized (EV-DO) network, an Enhanced Data Rates for GSM Evolution (EDGE) network, a 1G network, a 3GSM network, a 4GSM network, a Digital Enhanced Cordless Telecommunications (DECT) network , a Digital advanced mobile phone system (AMPS) (IS-136/time division multiple access (TDMA)) network, or an Integrated Digital Enhanced Network (iDEN) network, etc.). In other embodiments, the communication links are, for example, a local area network (LAN), a neighborhood area network (NAN), a home area network (HAN), or personal area network (PAN) employing any of a variety of communications protocols, such as Wi-Fi, Bluetooth, ZigBee, etc.

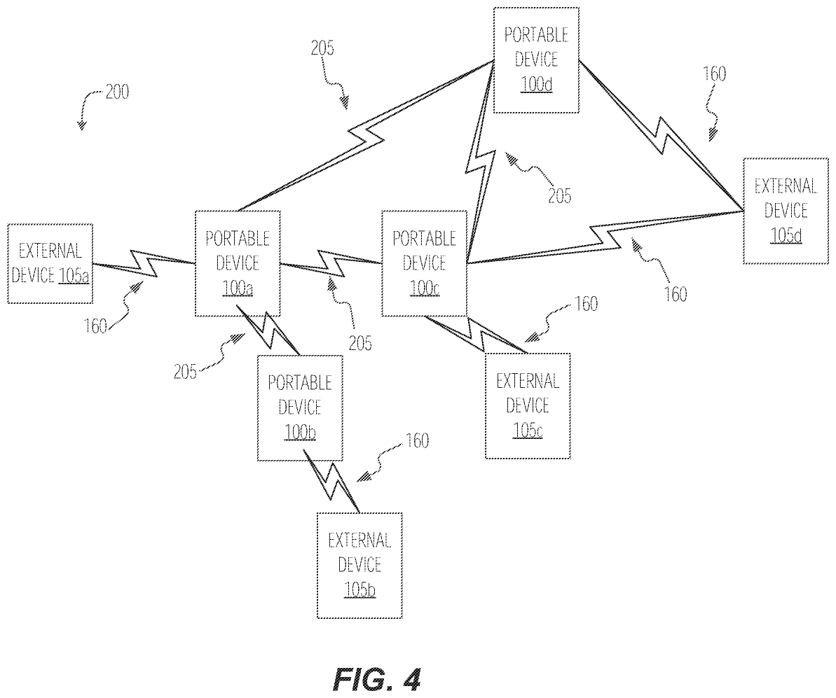

FIG. 4 illustrates a network 200 include a plurality of portable devices 100 according to some embodiments. As illustrated, network 200 is a network formed by two or more portable devices 100. For example as illustrated, portable device 100a may communicate with a second portable device 100b via communication link 205, thus extending the network 200 such that the second portable device 100b may provide network communication to external device 105b via communication link 160. As further illustrated, portable device 100a may further communicate directly with external device 105a via communication link 160. In some embodiments, communication links 205 are similar to (for example, use the same communication protocol as) communication links (or wireless connection) 160.

In some embodiments, network 200 is a mesh network, wherein portable devices 100a-100d communicate with each other to form network 200. For example, network 200 is a mesh network wherein the portable devices 100 connect to each other, rather than a central access point. In such an embodiment, the network 200 may be a full mesh network topology or a partial mesh network topology. Additionally, the network 200 may be use point-to-point topology, point-to-multipoint (or multipoint-to-point) topology, or multipoint-to-multipoint topology. As stated above, the network 200 may employ any of a variety of communications protocols, such as Wi-Fi, Bluetooth (and/or Bluetooth mesh, Bluetooth 5, etc.), ZigBee, Thread, Z-Wave, etc.

In some embodiments, one of the portable devices 100 (for example, portable device 100a) may be a primary portable device, while the remaining portable devices 100 (for example, portable devices 100b-100d) within the network 200 are secondary portable devices. In such an embodiment, the primary portable device may act as an access point to the network 200.

FIG. 5 illustrates a charging system 500 with network capabilities according to some embodiments. The system 500 may include a central charging station (or charging station) 505 configured to charge and/or communicate with one or more portable devices 100 (for example, portable devices 100a-100e). The charging station 505 includes a charger housing 510. As illustrated, the charging station 505 may be configured to receive one or more portable devices 100 (for example, via one or more receptacles located on the charger housing 510) or couple/connect to one or more portable devices 100. The portable devices 100 may then be removed by a user from the charging station 505. The charging station 505 may further include one or more central station indicators 515 located on the charger housing 510. The indicators 515 may be configured to output information to the user. For example, the information may include charge information, connection information, error information, and/or status information of one or more portable devices 100.

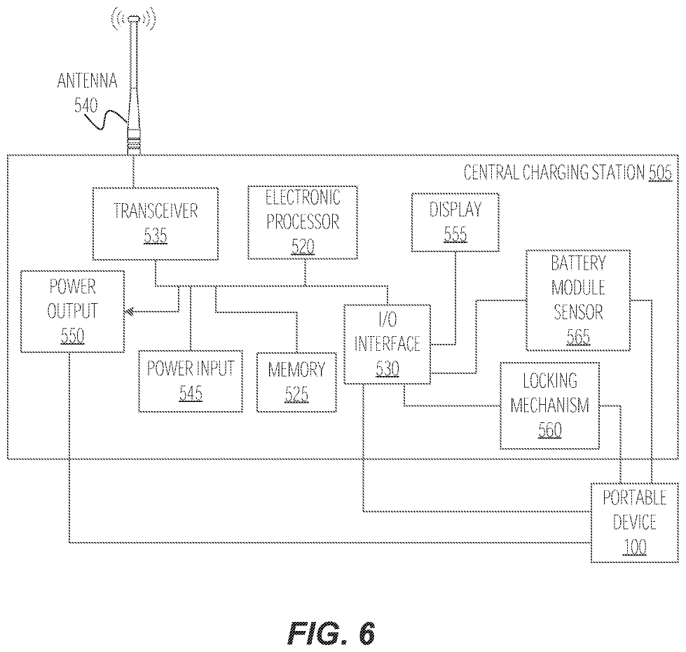

FIG. 6 illustrates a diagram of the charging system 500 according to some embodiments. Although illustrated as connecting and/or communicating with a single portable device 100, the system 500 may be configured to electrically connect and/or communicate with two or more portable devices 100 simultaneously (for example, portable devices 100a-100e of FIG. 5).

In the illustrated embodiment, the charging station 505 includes an electronic processor 520, a memory 525, an input and output (I/O) interface 530, a transceiver 535, an antenna 540, a power input 545, and a power output 550. In some embodiments, the charging station 505 also includes a display 555 (which may include, or be separate from, indicators 515). The illustrated components, along with other various modules and components are coupled to each other by or through one or more control or data buses that enable communication therebetween. The use of control and data buses for the interconnection between and exchange of information among the various modules and components would be apparent to a person skilled in the art in view of the description provided herein. In other constructions, the charging station 505 includes additional, fewer, or different components. For example, in some embodiments the charging station 505 includes one or more electronic sensors configured to sense an electric (for example, voltage, current, and/or power) and/or thermal characteristic of the charging station 505 and/or portable device(s) 110.

The electronic processor 520 obtains and provides information (for example, from the memory 525 and/or the I/O interface 530), and processes the information by executing one or more software instructions or modules, capable of being stored, for example, in a random access memory (“RAM”) area of the memory 525 or a read only memory (“ROM”) of the memory 525 or another non-transitory computer readable medium (not shown). The software can include firmware, one or more applications, program data, filters, rules, one or more program modules, and other executable instructions.

The memory 525 can include one or more non-transitory computer-readable media, and includes a program storage area and a data storage area. The program storage area and the data storage area can include combinations of different types of memory, as described herein. The memory 525 may include, among other things, a unique identifier for each portable device 100 to be coupled to the charging station 505. The electronic processor 520 is configured to retrieve from the memory 525 and execute, among other things, software related to the control processes and methods described herein.

The I/O interface 530 is configured to receive input and to provide output to one or more peripherals. The I/O interface 530 obtains information and signals from, and provides information and signals to, (for example, over one or more wired and/or wireless connections) devices both internal and external to the charging station 505. In some embodiments, the I/O interface 530 may include user-actuable devices (for example, a keypad, switches, buttons, soft keys, and the like) and indictor lights/devices (for example, light emitting diodes (LEDs), haptic vibrators, and the like).

The electronic processor 520 is configured to control the transceiver 535 to transmit and receive data to and from the charging station 505. The electronic processor 520 encodes and decodes digital data sent and received by the transceiver 535. The transceiver 535 transmits and receives radio signals to and from various wireless communications networks using the antenna 540. The electronic processor 520 and the transceiver 535 may include various digital and analog components, which for brevity are not described herein and which may be implemented in hardware, software, or a combination of both. Some embodiments include separate transmitting and receiving components, for example, a transmitter and a receiver, instead of a combined transceiver 535.

The display 555 may be any suitable display, for example, a liquid crystal display (LCD) touch screen, or an organic light-emitting diode (OLED) touch screen. In some embodiments, indicators 515 may be, or may be part of, the display 555. The charging station 505 may implement a graphical user interface (GUI) (for example, generated by the electronic processor 520, from instructions and data stored in the memory 525, and presented on the display 555), that enables a user to interact with the charging station 505. The graphical user interface may allow a user to view information regarding the central charging station. Such information may include the type and charging status of the connected portable devices 100 and the external devices coupled to the respective portable devices 100. The graphical user interface may also allow an authorized user to define and adjust virtual boundaries of one or more portable devices 100, install or remove additional portable devices 100 to the system 500, or remotely command one or more portable devices 100 to stop supplying power to, or prohibit network communication to one or more external devices, coupled to the one or more portable devices 100. The graphical user interface may allow interaction with the interface using gesture-based inputs or user-actuated switches/buttons. The graphical interface may be partially distributed on one or more additional external devices, for example a smartphone or tablet. In some embodiments, the external devices include one or more of the connected portable devices 100.

The power input 545 is configured to receive an input power. In some embodiments, the power input 545 is a power plug configured to receive the input power from an electrical socket. In some embodiments, the input power is approximately 110 VAC to approximately 120 VAC. In other embodiments, the input power is approximately 210 VAC to approximately 220 VAC.

As stated above, the charging station 505 is configured to be associated with one or more portable devices 100. The electronic processor 520 is configured to provide power to and communicate with the portable device(s) 110 through the I/O interface 530. The portable device 100 is configured to be coupled to the charging station 505 to be charged via a wired connection, receptacle to socket connection, or wirelessly (for example, via inductive charging). The portable device 100 is also removable from the charging station 505. When the portable device 100 is removed (no longer physically coupled to the charging station 505), the electronic processor 520 may communicate wirelessly with the portable device 100 via the transceiver 535.

Communication between the charging station 505 and various components including the portable device 100 can occur through the transceiver 535 and antenna 540. In some embodiments, communication between the charging station 505 and the one or more portable devices is performed via network 200. In some embodiments, the communication is, for example, a wide area network (WAN), a transport control protocol/internet protocol (TCP/IP) based network, a cellular network, such as, for example, a Global System for Mobile Communications (or Groupe Special Mobile (GSM)) network, a General Packet Radio Service (GPRS) network, a Code Division Multiple Access (CDMA) network, an Evolution-Data Optimized (EV-DO) network, an Enhanced Data Rates for GSM Evolution (EDGE) network, a 1G network, a 3GSM network, a 4GSM network, a Digital Enhanced Cordless Telecommunications (DECT) network , a Digital advanced mobile phone system (AMPS) (IS-136/time division multiple access (TDMA)) network, or an Integrated Digital Enhanced Network (iDEN) network, etc.). In other embodiments, the communication links 130/135 is, for example, a local area network (LAN), a neighborhood area network (NAN), a home area network (HAN), or personal area network (PAN) employing any of a variety of communications protocols, such as Wi-Fi, Bluetooth (and/or Bluetooth mesh, Bluetooth 5, etc.), ZigBee, Thread, Z-Wave, etc.

The charging station 505 may include one or more locking (or latching) mechanisms 560 configured to secure the portable devices 100 to the charging station 505. When in an unlocked position, the locking mechanism 560 allows removal of the portable device 100 by a user. When in the locked position, the locking mechanism 560 prevents removal of the portable device 100 by a user. In some embodiments, the portable device 100 includes a locking mechanism to lock itself to the charging station 505.

The locking mechanisms 560 may be configured to be electronically locked, where the locking mechanism 560 is operated (locked and unlocked) electronically or remotely (for example, “smart locked”). When the locking mechanisms 560 are configured to be electronically locked, they may be operated via electronic commands from a user interaction through the graphic user interface on the display 555, an input device of the input and output interface 530, and/or an electronic command from a remote device (for example, a smart phone, tablet, computer, or other personal electronic device) received via the transceiver 535. In some embodiments, the locking mechanisms 560 may be configured to be physically engaged (required to be manually locked and unlocked via a key, a turn of a knob, or the activation of a user-actuable device in order to be operated). In some embodiments the locking mechanism 560 may utilize more than one kind of locking/latching configuration. For example, in some embodiments, the locking mechanism 560 may be configured to both physically and electronically lock, wherein, when the locking mechanism 560 is configured to override/bypass the electronic lock when physically engaged, allowing a user to unlatch one or more of the portable devices 100 without an electronic command.

In some embodiments, the charging station 505 may include a device sensor 565 in (or proximate to) each of the power output port(s) 213 (for example, within each battery receptacle of the charging station 505). The device sensor 565 may be configured to sense when one or more of the portable devices 100 is present/coupled to the charging station 505. The device sensor 565 may be used in addition to the wireless and/or wired communication (for example, via the transceiver 535 and the I/O interface 530 and/or power output 550 respectively) between the charging station 505 and the battery(s) 110 as a separate means of determining when the portable device(s) 110 is placed in the charging station 505. For example, the device sensor 565 may be configured to read an identification label/chip (for example, a radio-frequency identification or RFID chip) of the portable device 100. This secondary communication may be used by the charging station 505 to determine if there is an issue/malfunction with the wireless/wired communication between the charging station 505 and the portable device(s) 110.

In one embodiment of general operation, one or more portable devices 100 are stored and/or charged by the charging station 505. A user removes a portable device 100 to charge and/or communicatively couple one or more external devices to the portable device 100. In some embodiments, the user must “check-out” the portable device 100 (for example, by providing name, identifiable information, and/or debit/credit card information) before removing the portable device 100 from the charging station 505.

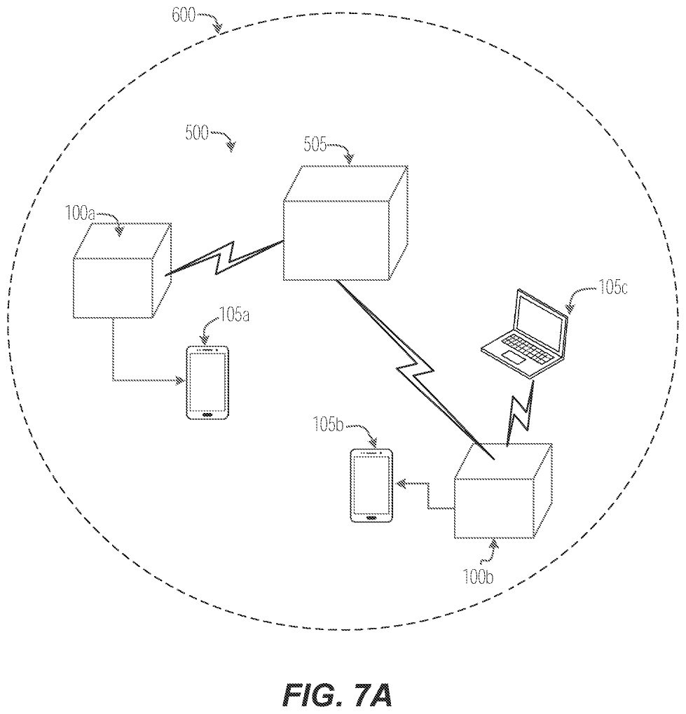

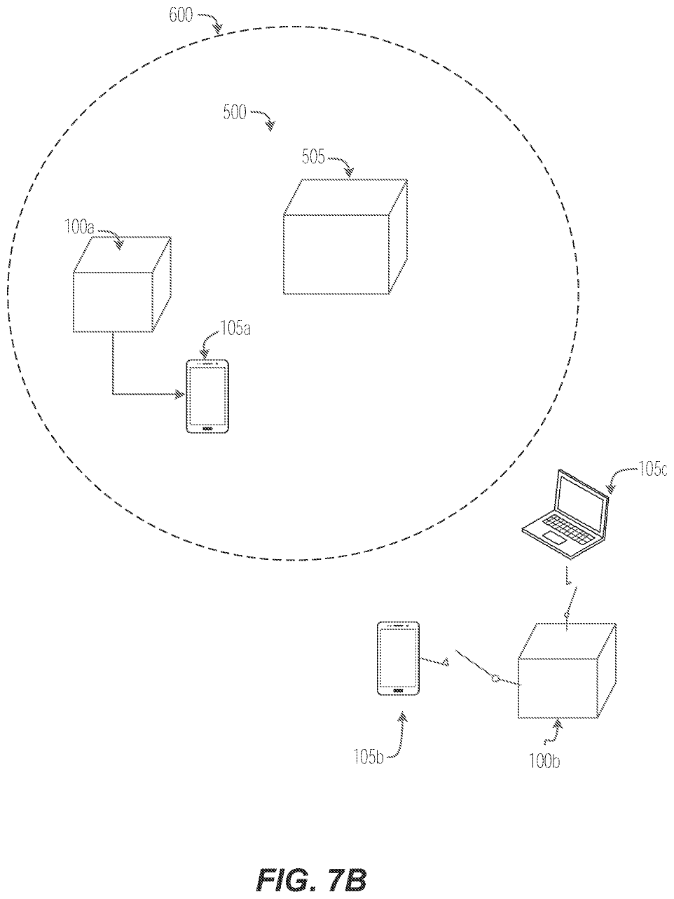

FIGS. 7A and 7B illustrate an example virtual boundary 600 of the system 500 according to some embodiments. The virtual boundary 600, or geofence, is a virtual boundary superimposed on an area. The area may be the area surrounding the charging station 505, an area proximate to the charging station 505, an area surrounding/proximate one or more portable devices 100, and/or any geographical area wherein one or more portable devices 100 are configured to operate. The configuration of the virtual boundary 600, for example the shape or the size, may be predefined or defined by a user via, for example, the display 555 and/or via a user device communicatively coupled to the system 500.

In some embodiments, the charging station 505 determines whether one or more of the portable devices 100 are within the virtual boundary 600. In such an embodiment, the charging station 505 may be configured to collect information based on monitoring the location and status of each of the portable devices 100. The location of the portable devices 100 may be determined via proximity sensors (not illustrated) or radio frequency communication, for example Bluetooth or radio frequency identification (RFID). In some embodiments, the portable devices 100 are tracked using, among other things, satellite navigation tracking (e.g., global navigation satellite system (GNSS) tracking, global positioning system (GPS) tracking, Galileo tracking, Indian Regional Navigation Satellite System (IRNSS) tracking, GLObal NAvigation System (GLONAS) tracking, BeiDou Navigation Satellite System, etc.) and WiFi-based tracking. In some embodiments, the portable devices 100 transmit information regarding their location to the charging station 505.

In other embodiments, a charging station 505 may not be used, and the location of the one or more portable devices 100 are monitored via a remote server using any of the above location tracking methods.

While the portable device 100 is within the virtual boundary 600, the portable device 100 is operable to provide power to charge and/or provide network communication to the one or more external devices 105. However, as illustrated in FIG. 7B, when one of the portable devices 100 (for example, portable device 100b) leaves, or is outside of, the virtual boundary 600, the portable device 100 prohibits power and/or network communication to the external devices 105b, 105c.

In some embodiments, the charging station 505 is configured to wirelessly charge the one or more portable devices 100 while the portable devices 100 are within a predetermined charging range of the charging station 505. The portable devices 100, while within this predetermined charging range, may then be wirelessly charged while charging one or more of the connected external devices 105. The predetermined charging range may be the same as or less than the range of the virtual boundary 600. For example, when the charging station 505 is located in a room within a commercial building, the virtual boundary 600 may be defined to encompass the entire commercial building while the predetermined charging range is limited to a single room within the commercial building. When this is the case, a user with the portable device 100 is able to charge or power an external device 105, as well as the portable device 100 while within the single room of the commercial building. When the user takes the portable device 100 outside the single room, leaving the predetermined charging range, the portable device 100 no longer receives a wireless charge from the charging station 505. However, the user is still able to use the portable device 100 to supply power to the one or more portable devices 100.

In some embodiments, the portable device 100 is configured to periodically determine an approximate distance the portable device 100 is from the charging station 505. For example, the portable device 100 may periodically ping the charging station 505 and use the information to approximate the distance of the portable device 100 from the charging station 505. In further embodiments, the portable device 100 may use the approximate distance to determine when the portable device 100 is outside the virtual boundary 600. The portable device 100 may then provide a visual/audible indication to the user to notify that they are outside the virtual boundary 600 and/or notify the charging station 505 that the portable device 100 is outside the virtual boundary 600. In some embodiments, the portable device 100 is configured to cease providing power/charging the external device(s) 105 when the portable device 100 determines that the portable device 100 is outside the virtual boundary. The portable device 100 may continue to approximate the distance from the charging station 505 and continue providing power/charging the external device(s) 105 when the portable device 100 determines that the portable device 100 is within the virtual boundary 600 again. In further embodiments, the portable device 100 is configured to stop powering/charging the external device(s) 105 and/or shut off after failing to receive a response from the charging station 505 after sending one or more ping requests.

In some embodiments, the portable devices 100 are not configured to provide power (for example, charging capabilities) to an external device 105. Rather, in such an embodiment, the portable devices 100 are configured to provide network access to external device(s) 105.

Embodiments provide, among other things, a portable charging system with network capabilities. Various features and advantages of the application are set forth in the following claims.

What is claimed is:

1. A portable charging system with network capabilities, the system comprising:
a portable device including
a rechargeable battery configured to supply a type of power to at least one external load device, and
a portable device transceiver configured to provide communication to an external device.

2. The system of claim 1, further comprising a second portable device including
a second rechargeable battery configured to supply a type of power to at least a second load device, and
a second portable device transceiver configured to provide communication to a second external device.

3. The system of claim 2, wherein at least one selected from a group consisting of the portable device and the second portable device acts as a network coordinator.

4. The system of claim 2, wherein the portable device transceiver and the second portable device transceiver uses a communication protocol.

5. The system of claim 4, wherein the communication protocol is at least one selected from a group consisting of WiFi, BLE, Bluetooth, Bluetooth Mesh, Bluetooth 5, Thread, Z-Wave, USB, Serial, LoRaWAN, and Zigbee.

6. The system of claim 2, further comprising a central transceiver.

7. The system of claim 6, wherein the central transceiver, the first portable device transceiver, and the second portable device transceiver form a network.

8. The system of claim 1, wherein the external load device and the external device are a single device.

9. The system of claim 1, wherein the portable device further includes a power source configured to charge the rechargeable battery.

10. The system of claim 9, wherein the power source includes at least one selected from a group consisting of a solar array and a generator.

11. The system of claim 1, wherein the portable device includes a power output configured to supply the type of power to the load device.

12. The system of claim 11, wherein the power output is isolated from the portable device transceiver.

13. The system of claim 1, further comprising:
a central station including
a central transceiver configured to provide communication, via the portable device, to the external device, and
an output port configured to supply power to the portable device when the portable device is coupled to the central station.

14. The system of claim 13, wherein the central station further includes an electronic processor configured to define a virtual boundary in which the portable device is expected to stay in;
determine a location of the portable device;
determine, based the location of the portable device, whether the portable device is within the virtual boundary; and
transmit a command to the portable device causing the portable device to perform at least one selected from a group consisting of: (1) stop supplying power to the load device and (2) stop providing communication to the external device, when the battery is not within the virtual boundary.

15. A method of operating a portable device, the method comprising:
supplying a type of power, via a rechargeable battery, to at least one external load device; and
providing communication, via a portable device transceiver, to an external device.

16. The method of claim 15, further comprising
supplying a type of power, via a second rechargeable battery of a second portable device, to at least a second load device; and
providing communication, via a second portable device transceiver of the second portable device, to a second external device.

17. The method of claim 16, wherein at least one selected from a group consisting of the portable device and the second portable device acts as a network coordinator.

18. The method of claim 17, wherein the portable device transceiver and the second portable device transceiver uses a communication protocol, wherein the communication protocol is at least one selected from a group consisting of WiFi, BLE, Bluetooth, Bluetooth Mesh, Bluetooth 5, Thread, Z-Wave, USB, Serial, LoRaWAN, and Zigbee.

19. The method of claim 15, wherein the external load device and the external device are a single device.

20. The method of claim 15, wherein the portable device includes a power output configured to supply the type of power, wherein the power output is isolated from the portable device transceiver.
